(19) United States
(12) Patent Application Publication
(10) Pub. No.: US 2024/0165580 A1
(43) Pub. Date: May 23, 2024

(54) PRODUCT COMPRISING A LITHIUM ADSORBENT

(71) Applicant: SAINT-GOBAIN CENTRE DE RECHERCHES ET D'ETUDES EUROPEEN, COURBEVOIE (FR)

(72) Inventor: Patrick NGUYEN VAN NUOI, NOVES (FR)

(21) Appl. No.: 18/550,174

(22) PCT Filed: Mar. 7, 2022
(86) PCT No.: PCT/FR2022/050403

§ 371 Date: Sep. 12, 2023

(30) Foreign Application Priority Data
Mar. 12, 2021 (FR) 2102483

(51) Int. Cl. B01J 20/04; B01J 20/08; B01J 20/24; B01J 20/28

(52) U.S. Cl. CPC B01J 20/041; B01J 20/08; B01J 20/24; B01J 20/28019; B01J 20/2803; B01J 20/28047; B01J 2220/48

(57) ABSTRACT

A product for the extraction of lithium from a brine, the product including particles bound by a binder, the binder including a gelled polysaccharide including a group establishing an ionic bond with a divalent cation, a trivalent cation and mixtures thereof, the particles being essentially particles of a lithium adsorbent.

### TECHNICAL FIELD

The present invention relates to a product comprising a lithium adsorbent and to a method for producing products comprising a lithium adsorbent.

### PRIOR ART

The use of lithium, especially in batteries, is constantly increasing.

Brines are sources of lithium, for which extraction of said lithium is necessary.

This extraction, or capture, can be carried out using columns filled with an active material, which selectively and reversibly captures lithium when the brine is in contact with it.

Lithium is then recovered by passing slightly saline, acidified water into these columns. This results in a concentrated lithium solution which will be purified before a precipitation step, generally in the form of lithium carbonate.

Lithium adsorbents are materials advantageously used as an active material for obtaining the concentrated lithium solution within the extraction columns.

Application KR20190078350 describes different lithium adsorbent materials in a lithium capture application.

Application WO2018002336 describes a material for the capture of lithium of formula (LiCl)ₓ·2Al(OH)₃, nH₂O where x is between 0.4 and 1 and n is between 0.01 and 10.

Application CN103212388 describes a method for selectively and irreversibly extracting radioactive ions of rubidium and cesium from a brine containing such ions, in particular one derived from radioactive nuclear waste, based on a solution comprising a sodium alginate hydrosol and a potassium tetraphenylborate powder.

Lithium capture is accompanied by an increase in volume of the lithium adsorbent material located in the extraction column. Then, when the lithium is subsequently recovered by passing slightly saline, acidified water into these columns, the volume of the lithium adsorbent material decreases. Said material thus undergoes repeated cycles of increasing and decreasing volume that may lead to degradation of its shape and therefore to a reduction in the effectiveness of lithium capture.

There is a need for products based on a lithium adsorbent, obtained by shaping a powder, optionally moistened, said products having good resistance to repetitive lithium adsorption-desorption cycles in the application.

One aim of the invention is to at least partially meet this need.

### DISCLOSURE OF THE INVENTION

According to the invention, this aim is achieved by means of a product advantageously allowing the facilitated extraction of lithium, said product comprising particles bound by a binder, said binder comprising a gelled polysaccharide comprising a group establishing an ionic bond with a divalent cation, a trivalent cation and mixtures thereof, said particles being essentially, preferably, particles of a lithium adsorbent. Preferably, the binder consists of said gelled polysaccharide.

According to preferred but non-limiting embodiments of the present invention, which may, if appropriate, be combined with one another:
the gelled polysaccharide comprises a group establishing an ionic bond with an alkaline earth cation, preferably selected from the cations of Ca, Sr, Ba and mixtures thereof, preferably with a cation of Ca.
the group is chosen from carboxylate groups (—COO—) or sulfonate groups(—SO₃⁻), even more preferably said group is a carboxylate group.
the gelled polysaccharide is a gelled alginate under the action of a divalent cation, a trivalent cation and mixtures thereof, preferably under the action of a divalent cation, more preferably under the action of a calcium cation.
the gelled polysaccharide is a pectin gelled under the action of a divalent cation, a trivalent cation and mixtures thereof, preferably under the action of a divalent cation, more preferably under the action of a calcium cation.
the lithium adsorbent is selected from:
a lithiated bayerite, preferably a material of formula (LiCl)ₓ·2Al(OH)₃, nH₂O, where x is between 0.4 and 1 and n is between 0.01 and 10;
a lithium aluminate, optionally hydrated and/or doped, said lithium aluminate preferably corresponding to the formula LiAlO₂ optionally hydrated and/or doped;
an optionally doped manganese spinel, said manganese spinel preferably being chosen from a manganese spinel of formula Li₍₁₊ₓ₎Mn_{(2-y)}M′_{y}O₄ where −0.20≤x≤0.4 and 0≤y≤1, the element M′ being selected from aluminum, cobalt, nickel, chromium, iron, magnesium, titanium, vanadium, copper, zinc, gallium, calcium, niobium, yttrium, barium, silicon, boron, zirconium, lithium and mixtures thereof, the electroneutrality of said lithium manganate being ensured by the oxygen content;
a lithiated iron oxide, optionally hydrated and/or doped, said lithiated iron oxide preferably corresponding to the formula LiFeO₂ optionally hydrated and/or doped;
A lithiated magnesium oxide, optionally hydrated and/or doped, said lithiated magnesium oxide preferably corresponding to the formula LiMgO₂ optionally hydrated and/or doped;
A cobalt and lithium spinel, optionally hydrated and/or doped, said cobalt and lithium spinel preferably corresponding to the formula LiCo₂O₄ optionally hydrated and/or doped;
A lithium titanate, optionally hydrated and/or doped, said lithium titanate preferably being chosen from a lithium titanate corresponding to the formula LiTiO₂, Li₂TIO₃, Li₂Ti₃O₇, Li₄TisO₁₂, and mixtures thereof, optionally hydrated and/or doped, preferably Li₂TiO₃ optionally hydrated and/or doped;
H₂TiO₃ optionally hydrated and/or doped;
H₂Ti₃O₇ optionally hydrated and/or doped;
H₄TisO₁₂, optionally hydrated and/or doped;
and mixtures thereof.
the lithium adsorbent is selected from:
a lithiated bayerite, preferably a material of formula (LiCl)ₓ·2Al(OH)₃, nH₂O, where x is between 0.4 and 1 and n is between 0.01 and 10;
an optionally doped lithium and manganese spinel;
a lithium titanate, optionally hydrated and/or doped, said lithium titanate preferably being chosen from a lithium titanate corresponding to the formula LiTiO₂, Li₂TiO₃, Li₂Ti₃O₇, Li₄TisO₁₂, and mixtures thereof, optionally hydrated and/or doped, preferably Li₂TiO₃ optionally hydrated and/or doped;
H₂TiO₃ optionally hydrated and/or doped;
and mixtures thereof.
the lithium adsorbent is lithiated bayerite, preferably a material of formula (LiCl)ₓ·2Al(OH)₃, nH₂O, where x is between 0.4 and 1 and n is between 0.01 and 10.
the mass quantity of particles of a lithium adsorbent, after drying at 100° C. for 12 hours, is greater than or equal to 95% and less than 99.9%, based on the mass of said product after drying at 100° C. for 12 hours.
The product is in the form of cylinders, polylobes, rings, or spheres, the greatest dimension of which is less than 100 mm, preferably less than 80 mm, preferably less than 50 mm and the smallest dimension of which, in a plane perpendicular to the direction of the largest dimension, is greater than 1 μm.

The products comprising a lithium adsorbent described above, in particular in the form of macroscopic objects, have an improved resistance to repetitive lithium adsorption-desorption cycles in particular in lithium extraction columns described previously.

The invention also relates to a method for manufacturing a product comprising a lithium adsorbent, in particular a product as described above, comprising at least the following steps:
a) mixing raw materials to form a feedstock, said feedstock comprising a powder of a lithium adsorbent, and a polysaccharide that gels under the action of a gelling agent, the mass ratio of the quantity of said polysaccharide to the total amount of said polysaccharide and the powder of a lithium adsorbent being preferably greater than or equal to 0.1% and preferably less than or equal to 10%, even more preferably less than or equal to 5%,
b) shaping said feedstock, so as to obtain a preform,
c) contacting said preform with said gelling agent and gelling said polysaccharide so as to obtain said product comprising a lithium adsorbent,
d) optionally drying said product comprising a lithium adsorbent.

According to preferred but non-limiting embodiments of the present invention, which may, if appropriate, be combined with one another:
the lithium adsorbent is lithiated bayerite, preferably a material of formula (LiCl)ₓ·2Al(OH)₃, nH₂O, where x is between 0.4 and 1 and n is between 0.01 and 10.
the polysaccharide is an alginate or a pectin, preferably an alginate.
the gelling agent is chosen from Ca, Sr, Ba and mixtures thereof, preferably the gelling agent is Ca.

The invention also relates to a product obtainable by the method as described above.

Finally, the invention relates to a device for collecting lithium, in particular an extraction column, comprising a product according to the invention or a product obtained or obtainable by the method according to the invention as described above.

### Definitions

“Lithium adsorbent” is any material capable of retaining lithium in its structure by adsorption, in particular chemical or physical, and/or by exchanging an ion of its structure with a Lit ion. A lithiated bayerite, in particular a material of formula (LiCl)ₓ·2Al(OH)₃, nH₂O where x is between 0.4 and 1 and n is between 0.01 and 10, is an example of lithium adsorbent material.
“Lithiated bayerite” is the compound of formula LiCl·2Al(OH)₃·nH₂O as indicated in the ICDD PDF 00-031-0700, but by extension, compounds with a molar ratio of lithium and aluminum, Li/Al, other than 0.5 are called by the same name. In some modes, it may be less than 0.5. According to other modes, it may be greater than 0.5.
“Polysaccharides”, according to the classical definition, are polymers composed of chains of saccharide units linked by glycosidic bonds.
The term “gelable polysaccharide” under the action of a gelling agent is a polysaccharide capable of forming a gel under the action of said gelling agent.
A gelled polysaccharide results from the association of chains of the polysaccharide under the action of a gelling agent. By way of example, alginate has the formula (C₆H₇O₆⁻)ₙ. Alginate is a polysaccharide chain comprising carboxyl groups (COO⁻). Ca2+ calcium ions (gelling agent) react with two strands of alginate, that is to say with the carboxyl groups COO⁻, resulting in the polymerization of the alginate chains and the binding of the molecules to each other. The reaction allows the creation of a gel.

All the percentages in the present description are percentages by weight, unless indicated otherwise.

The verbs “contain”, “comprise” and “have” should be interpreted broadly and without limitation, unless indicated otherwise.

### DETAILED DESCRIPTION

A manufacturing method according to the invention will now be detailed.

In step a), the feedstock comprises at least one lithium adsorbent powder.

In the method according to the invention, the lithium adsorbent powder(s) may be provided not only in a dry form, but also in a wet form, for example in the form of a suspension and/or a paste.

In one embodiment, in particular when the feedstock contains a lithiated bayerite powder, preferably a powder of a material of formula (LiCl)ₓ·2Al(OH)₃, nH₂O, where x is between 0.4 and 1.0 and n is between 0.01 and 10, said powder is provided in a wet form, preferably in the form of a suspension and/or paste.

In one embodiment, the feedstock comprises at least two lithium adsorbent powders, preferably at least two of said lithium adsorbent powders are made of a different lithium adsorbent.

In one preferred embodiment, the feedstock does not comprise a lithium adsorbent powder.

Preferably, the lithium adsorbent is selected from:
a lithiated bayerite, preferably a material of formula (LiCl)ₓ·2Al(OH)₃, nH₂O, where x is between 0.4 and 1 and n is between 0.01 and 10;
a lithium aluminate, optionally hydrated and/or doped, said lithium aluminate preferably corresponding to the formula LiAlO₂ optionally hydrated and/or doped;
an optionally doped manganese spinel, said manganese spinel preferably being chosen from a manganese spinel of formula Li₍₁₊ₓ₎Mn_{(2-y)}M′_{y}O₄ where −0.20≤x≤0.4 and 0≤ y≤1, the element M′ being selected from aluminum, cobalt, nickel, chromium, iron, magnesium, titanium, vanadium, copper, zinc, gallium, calcium, niobium, yttrium, barium, silicon, boron, zirconium, lithium and mixtures thereof, the electroneutrality of said lithium manganate being ensured by the oxygen content;
a lithiated iron oxide, optionally hydrated and/or doped, said lithiated iron oxide preferably corresponding to the formula LiFeO₂ optionally hydrated and/or doped;
A lithiated magnesium oxide, optionally hydrated and/or doped, said lithiated magnesium oxide preferably corresponding to the formula LiMgO₂ optionally hydrated and/or doped;
A cobalt and lithium spinel, optionally hydrated and/or doped, said cobalt and lithium spinel preferably corresponding to the formula LiCo₂O₄, optionally hydrated and/or doped;
A lithium titanate, optionally hydrated and/or doped, said lithium titanate preferably being chosen from a lithium titanate corresponding to the formula LiTiO₂, Li₂TiO₃, Li₂Ti₃O₇, Li₄T₁₅O₁₂, and mixtures thereof, optionally hydrated and/or doped, preferably Li₂TiO₃ optionally hydrated and/or doped;
H₂TiO₃ optionally hydrated and/or doped;
H₂Ti₃O₇ optionally hydrated and/or doped;
H₄T₁₅O₁₂, optionally hydrated and/or doped;
And mixtures thereof.

Preferably, the lithium adsorbent is selected from:
a lithiated bayerite, preferably a material of formula (LiCl)ₓ·2Al(OH)₃, nH₂O, where x is between 0.4 and 1 and n is between 0.01 and 10;
an optionally doped lithium and manganese spinel;
a lithium titanate, optionally hydrated and/or doped, said lithium titanate preferably being chosen from a lithium titanate corresponding to the formula LiTiO₂, Li₂TiO₃, Li₂Ti₃O₇, Li₄T₁₅O₁₂, and mixtures thereof, optionally hydrated and/or doped, preferably Li₂TiO₃ optionally hydrated and/or doped
H₂TiO₃ optionally hydrated and/or doped;
and mixtures thereof.

Preferably, the lithium adsorbent is lithiated bayerite, preferably a material of formula (LiCl)ₓ·2Al(OH)₃, nH₂O, where x is between 0.4 and 1 and n is between 0.01 and 10.

Preferably, the median size of the lithium adsorbent powder is greater than 0.1 μm and/or less than 100 μm.

The feedstock contains a polysaccharide comprising a group capable of forming an ionic bond with a gelling agent chosen from divalent cations, trivalent cations (for example a cation of Fe or Al) and mixtures thereof for the formation of a gelled polysaccharide, in particular in an amount such that the mass ratio of the amount of said polysaccharide to the total amount of said polysaccharide and of the lithium adsorbent powder is greater than or equal to 0.1% and preferably less than or equal to 10%, more preferably less than 5%. Preferably, said mass ratio is greater than or equal to 0.2%, preferably greater than or equal to 0.3%, and preferably less than or equal to 4%, preferably less than or equal to 3%, preferably less than or equal to 2%, preferably less than or equal to 1%.

Preferably, the group of polysaccharide capable of forming an ionic bond with a gelling agent chosen from divalent cations, trivalent cations and mixtures thereof, is chosen from a carboxylate group COO⁻ or a sulfonate group SO₃⁻, more preferably said group is a carboxylate group COO⁻.

Preferably, the polysaccharide comprises a group capable of forming an ionic bond with a gelling agent chosen from alkaline earth metal cations, preferably chosen from Ca, Sr, Ba cations and mixtures thereof. Preferably, the polysaccharide comprises a group capable of forming an ionic bond with a Ca cation.

Preferably, the polysaccharide comprising a group capable of forming an ionic bond with a gelling agent is chosen from alginates and pectins.

Preferably, the polysaccharide comprising a group capable of forming an ionic bond with a gelling agent is chosen from alginates, preferably from sodium alginates, potassium alginates, ammonium alginates and mixtures thereof. Preferably the alginate is an ammonium alginate.

Preferably, the feedstock contains a powder of a lithium adsorbent and a polysaccharide comprising a group capable of forming an ionic bond with a gelling agent chosen from divalent cations, trivalent cations and mixtures thereof.

In the method according to the invention, the polysaccharide comprising a group capable of forming an ionic bond with a gelling agent chosen from divalent cations, trivalent cations and mixtures thereof, preferably alginate, can be provided in the form of a solution.

As is well known to the skilled person, the feedstock may comprise, in addition to the lithium adsorbent powder(s) and polysaccharide comprising a group capable of forming an ionic bond with a gelling agent chosen from divalent cations, trivalent cations and mixtures thereof, a solvent and/or an organic binder and/or a plasticizer and/or a lubricant and/or pore-forming particles, the natures and amounts of which are adapted to the shaping method of step b).

Preferably the solvent is water. The amount of solvent is adapted to the shaping method carried out in step h) as well as to the presence of polysaccharide comprising a group capable of forming an ionic bond with a gelling agent chosen from divalent cations, trivalent cations and mixtures thereof in the feedstock.

In one embodiment, in particular when the feedstock contains an amount of solvent, preferably water, which is too large compared with the shaping method envisaged in step b), particularly when the lithium adsorbent is provided in wet form, a step of removing part of the solvent may be carried out, before step b).

The feedstock optionally contains an organic binder facilitating the formation of the preform, preferably in a content of between 0.1% and 10%, preferably between 0.2% and 2% by mass based on the mass of the lithium adsorbent powder(s) of the feedstock.

All the organic binders conventionally used for the manufacture of porous ceramic products can be implemented, for example polyvinyl alcohol (PVA) or polyethylene glycols (PEG), methylstearate, ethylstearate, waxes, polyolefins, polyolefin oxides, glycerin, propionic acid, maleic acid, benzyl alcohol, isopropanol, butyl alcohol, a dispersion of paraffin and polyethylene, and mixtures thereof.

The feedstock optionally contains a plasticizer, which also facilitates the formation of the preform.

Preferably, the plasticizer content is between 0.1% and 10%, preferably between 0.5% and 5%, by weight based on the weight of the lithium adsorbent powder(s) of the feedstock. The plasticizer may constitute a binder.

All the plasticizers conventionally used for the manufacture of porous ceramic products can be used, for example polyethylene glycol, polyolefin oxides, hydrogenated oils, alcohols, in particular glycerol and glycol, esters, and mixtures thereof.

The feedstock optionally contains a lubricant, which also facilitates the formation of the preform. Preferably, the plasticizer content is between 0.1% and 10%, preferably between 0.5% and 5%, by weight of the lithium adsorbent powder(s) of the feedstock.

All the lubricants conventionally used for the manufacture of porous ceramic products can be used, for example petroleum jelly and/or glycerin and/or waxes.

The feedstock optionally contains pore-forming particles, well known to a skilled person, which are intended to be eliminated during the method according to the invention, thus leaving the space to pores. Their quantity and dimensions are chosen so as in particular to adjust the porous volume in the lithium adsorbent-based product obtained at the end of step b) or c). Preferably, said pore-forming particles are made of a material soluble in the solvent.

The presence and nature of the binder and/or lubricant depend in particular on the shaping technique used in step b).

In one preferred embodiment, the feedstock does not contain constituents other than the lithium adsorbent powder(s), polysaccharide, a solvent, an acid, an organic binder, a plasticizer, a lubricant and pore-forming particles.

Preferably, the polysaccharide, preferably alginate, and the solvent, preferably water, are mixed so as to obtain an intimate mixture. Next, the other constituents of the feedstock, in particular the lithium adsorbent powder(s), the binder, lubricant, plasticizer and optional pore-forming particles are added with stirring.

In one embodiment, the amount of solvent, preferably water, can be added in several stages, in an amount determined according to the technique chosen for shaping.

In one embodiment, when the lithium adsorbent powder is supplied by a suspension and/or a paste, the solvent, preferably water, is introduced, at least in part, by said suspension and/or said paste.

The mixing of the various constituents of the feedstock can be carried out according to any technique known to the skilled person, for example in a mixer, preferably in a high intensity mixer or in a Z-arm mixer, in turbulate, in a jar mill with balls, preferably alumina beads. The mixing is preferably carried out in a high intensity mixer or in a Z-arm mixer

The total mixing time is preferably greater than 5 minutes, and preferably less than 30 minutes, preferably less than 20 minutes.

Step b) may be preceded by a step of removing at least part of the solvent, so as to adapt the amount of solvent, preferably water, to the shaping technique envisaged in step b). All known techniques for removing at least in part a solvent, preferably water, can be used, preferably drying, preferably in air, at atmospheric pressure. Preferably, the maximum temperature reached during said drying is greater than 20° C., and preferably less than 100° C., preferably less than 80° C., preferably less than 60° C.

Also preferably, the drying cycle has a plateau at said maximum temperature reached. The holding time at the plateau is preferably greater than 1 hour, preferably less than 20 hours, preferably less than 15 hours.

In step b), the feedstock is shaped so as to obtain a preform.

Shaping can be carried out according to any technique known to a person skilled in the art, for example extrusion, granulation, pressing, casting, atomization, screen printing, tape casting, or drip casting.

The preforms obtained can be in the form of cylinders, polylobes, rings, or spheres.

In step c), the preform is brought into contact with a solution comprising a gelling agent chosen from divalent cations, trivalent cations and mixtures thereof, capable of gelling the polysaccharide, so as to obtain the product based on a lithium adsorbent.

The solution comprising a gelling agent chosen from divalent cations, trivalent cations and mixtures thereof, capable of gelling the polysaccharide is well known to the person skilled in the art.

The gelling agent is preferably chosen from alkaline-earth cations, preferably chosen from the cations of Ca, Sr, Ba and mixtures thereof. Preferably, the gelling agent is a Ca cation.

The solution containing the gelling agent preferably selected from divalent cations, a trivalent cations and mixtures thereof is preferably chosen from a solution comprising a divalent cation salt, a solution comprising a trivalent cation salt, or the lithium source from which lithium is extracted, preferably brine, in particular when it contains such a cation.

Preferably, the solution comprising a divalent cation salt or a trivalent cation salt is selected from an iodide solution of said cation and/or a chloride solution of said cation.

Preferably, the gelling solution is a solution comprising an alkaline-earth cation iodide and/or an alkaline-earth cation chloride. Also preferably, the gelling solution is a solution comprising an alkaline-earth cation chloride, preferably a solution comprising calcium chloride.

In a preferred embodiment, the gelling solution is the source of lithium from which the lithium is extracted, preferably brine from which the lithium is to be collected, especially when the latter comprises a divalent and/or trivalent cation.

In another possible embodiment, the gelling solution is a calcium chloride solution, the calcium chloride concentration of which is preferably greater than 1 mol/l, preferably greater than 2 mol/l of solution.

Contact may for instance be achieved by immersing the preform in a bath of gelling solution or by spraying the preform with the gelling solution.

In one embodiment, step b) and step c) are coincident, in particular when the preform is implemented by drop-by-drop gelling.

At the end of step c), a lithium adsorbent-based product is obtained. The lithium adsorbent-based product can be in the form of cylinders, polylobes, rings, or spheres.

Preferably, the preform is shaped so that the largest dimension of the lithium adsorbent-based product is less than 100 mm, preferably less than 80 mm, preferably less than 50 mm, preferably less than 30 mm, or even less than 10 mm and/or so that the smallest dimension of the lithium adsorbent-based product in a plane perpendicular to the direction of the largest dimension is greater than 1 μm, or even greater than 10 μm (micrometers).

In step d), which is optional, the lithium adsorbent-based product is dried.

Preferably, the maximum temperature reached during said drying is greater than 20° C., and preferably less than 140° C., preferably less than 100° C., preferably less than 80° C.

Also preferably, the drying cycle has a plateau at said maximum temperature reached. The holding time at the plateau is preferably greater than 1 hour, preferably greater than 2 hours, preferably greater than 5 hours and preferably less than 20 hours, preferably less than 15 hours. Drying is preferably carried out in air at atmospheric pressure.

At the end of step d), a lithium adsorbent-based dry product is obtained.

The invention also relates to a product comprising particles bound by a binder, said binder preferably consisting of a gelled polysaccharide comprising a group establishing an ionic bond with a divalent cation, a trivalent cation and mixtures thereof, preferably a gelled alginate, said particles being essentially particles of a lithium adsorbent.

Such a product is in particular derived from a method as described above.

Preferably, the binder of the product comprising a lithium adsorbent according to the invention preferably consists essentially of, a gelled polysaccharide comprising a group establishing an ionic bond with a divalent cation, a trivalent cation and mixtures thereof, preferably with an alkaline-earth cation, preferably chosen from the cations of Ca, Sr, Ba and mixtures thereof, preferably a Ca cation.

Preferably said gelled polysaccharide is a gelled alginate or a gelled pectin, preferably a gelled alginate.

In the product (or macroscopic object) comprising a lithium adsorbent according to the invention, the gelled polysaccharide, in particular the gelled alginate, contained in the binder may be, for example, demonstrated by size-exclusion chromatography.

Preferably, the product comprising a lithium adsorbent according to the invention consists essentially, after drying at 100° C. for 12 hours, by particles of a lithium adsorbent, bound by a binder essentially consisting of a gelled alginate.

Preferably, the particles of a lithium adsorbent of the product comprising a lithium adsorbent according to the invention are particles of a lithium adsorbent selected from:
a lithiated bayerite, preferably a material of formula (LiCl)ₓ 0.2Al(OH)₃, nH₂O, where x is between 0.4 and 1 and n is between 0.01 and 10;
a lithium aluminate, optionally hydrated and/or doped, said lithium aluminate preferably corresponding to the formula LiAlO₂ optionally hydrated and/or doped;
an optionally doped manganese spinel, said manganese spinel preferably being chosen from a manganese spinel of formula Li₍₁₊ₓ₎Mn_{(2-y)}M′_{y}O₄ where −0.20≤x≤0.4 and 0≤y≤1, the element M′ being selected from aluminum, cobalt, nickel, chromium, iron, magnesium, titanium, vanadium, copper, zinc, gallium, calcium, niobium, yttrium, barium, silicon, boron, zirconium, lithium and mixtures thereof, the electroneutrality of said lithium manganate being ensured by the oxygen content;
a lithiated iron oxide, optionally hydrated and/or doped, said lithiated iron oxide preferably corresponding to the formula LiFeO₂ optionally hydrated and/or doped;
A lithiated magnesium oxide, optionally hydrated and/or doped, said lithiated magnesium oxide preferably corresponding to the formula LiMgO₂ optionally hydrated and/or doped;
A cobalt and lithium spinel, optionally hydrated and/or doped, said cobalt and lithium spinel preferably corresponding to the formula LiCo₂O₄ optionally hydrated and/or doped;
A lithium titanate, optionally hydrated and/or doped, said lithium titanate preferably being chosen from a lithium titanate corresponding to the formula LiTiO₂, Li₂TiO₃, Li₂Ti₃O₇, Li₄T₁₅O₁₂, and mixtures thereof, optionally hydrated and/or doped, preferably Li₂TiO₃ optionally hydrated and/or doped;
H₂TiO₃ optionally hydrated and/or doped;
H₂Ti₃O₇ optionally hydrated and/or doped;
H₄T₁₅O₁₂, optionally hydrated and/or doped;
And mixtures thereof.

Preferably, the lithium adsorbent is selected from:
a lithiated bayerite, preferably a material of formula (LiCl)ₓ·2Al(OH)₃, nH₂O, where x is between 0.4 and 1 and n is between 0.01 and 10;
an optionally doped lithium and manganese spinel;
a lithium titanate, optionally hydrated and/or doped, said lithium titanate preferably being chosen from a lithium titanate corresponding to the formula LiTiO₂, Li₂TiO₃, Li₂Ti₃O₇, Li₄T₁₅O₁₂, and mixtures thereof, optionally hydrated and/or doped, preferably Li₂TiO₃ optionally hydrated and/or doped;
H₂TiO₃ optionally hydrated and/or doped;
and mixtures thereof.

Preferably, the lithium adsorbent is lithiated bayerite, preferably a material of formula (LiCl)ₓ·2Al(OH)₃, nH₂O, where x is between 0.4 and 1 and n is between 0.01 and 10.

In one embodiment, when the lithium adsorbent-based product according to the invention comprises a mixture of at least two populations of lithium adsorbent particles, at least two of said populations of lithium adsorbent particles are of a different lithium adsorbent.

Preferably, in the product comprising a lithium adsorbent according to the invention, the mass ratio of the quantity of the gelled polysaccharide to the total amount of said gelled polysaccharide and the particles of a lithium adsorbent is greater than or equal to 0.1%, preferably greater than or equal to 0.2%, preferably greater than or equal to 0.3% and preferably less than or equal to 10%, more preferably less than or equal to 5%, preferably less than or equal to 4%, preferably less than or equal to 3%, preferably less than or equal to 2%, preferably less than or equal to 1%. Advantageously, the quantity of lithium adsorbent particles in the product is greater for the same volume.

Preferably, in the product comprising a lithium adsorbent according to the invention, the quantity by mass of lithium adsorbent particles, after drying at 100° C. for 12 hours, is greater than or equal to 90%, preferably greater than 95%, preferably greater than or equal to 96%, preferably greater than or equal to 97%, preferably greater than or equal to 98%, and less than 99.9%, preferably less than 99.8%, preferably less than 99.7%, based on the mass of the product comprising a lithium adsorbent according to the invention, after drying at 100° C. for 12 hours.

The lithium adsorbent-based product according to the invention can be in the form of cylinders, polylobes, rings, or spheres.

Preferably, the largest dimension of the lithium adsorbent-based product according to the invention (or macroscopic object according to the invention) is less than 100 mm, preferably less than 80 mm, preferably less than 50 mm, preferably less than 30 mm, or less than 10 mm. More preferably, the smallest dimension of the lithium adsorbent-based product according to the invention (or macroscopic object according to the invention), in a plane perpendicular to the direction of the largest dimension, is greater than 1 μm or even greater than 10 μm.

The invention also relates to a lithium adsorbent-based product obtained or obtainable by the method according to the invention. This product is remarkable due to its ability to retain its physical integrity during a repetitive cycling of lithium adsorption-desorption. This property also constitutes a signature of the method according to the invention.

### Examples

The following non-limiting examples are given with the aim of illustrating the invention.

Measurement Protocols

The water content of a paste is determined as the loss of mass, expressed as a percentage, after drying in air at 200° ° C. for 16 hours

The nature of the crystallized phases of the pastes manufactured in the examples is determined by the following conventional method:

The pastes of the examples are previously air-dried for 170 hours at 25° C.

The acquisitions are carried out by means of an X′Pert type apparatus from Panalytical, equipped with a copper anode, over an angular range 20 of between 5° and 80°, with a step of 0.017°, and a counting time of 300 s/step. The front lens has a fixed divergence slit of 0.25°, a Soller slit of 0.02 rad, a mask of 10 mm and a fixed anti-scatter slit of 0.5°. The sample is rotating on itself. The rear optics feature a fixed 0.25° anti-scatter slit, a 0.02 rad Soller slit and a nickel filter.

The diffraction diagrams are then analyzed qualitatively using the EVA software and the ICDD2016 database.

The ICDD2016 PDF data sheet 00-031-0700 identifies the phase (LiCl)·2Al(OH)₃, xH₂O.

The crystallized phase of lithiated bayerite demonstrated may exhibit a slight angular shift of the peaks with respect to said data sheet, a consequence in particular of the quantity of Li inserted into the structure of the lithiated bayerite.

The content of the elements other than H and O, partly Li, CI and Al, is determined on pastes air-dried at 200° ° C. for 16 hours, by inductively coupled plasma spectrometry, using an Agilent 5800 ICP-OES apparatus.

### Manufacturing Protocol:

The following raw materials were used for the examples:
Aluminum trichloride hexahydrate AlCl₃,6H₂O, of purity greater than 99% by mass, marketed by Merck, for example 1,
A sodium hydroxide NaOH powder, of purity greater than 99% by mass, marketed by Merck, for example 1,
Oxalic acid, with a purity greater than 99% by mass, marketed by Merck, for example 1,
A gibbsite Al(OH)₃ powder, having a median size equal to 1.6 μm, of purity greater than 99.5% by mass and a specific surface area equal to 5 m²/g, for example 2,
Lithium hydroxide monohydrate (LiOH, H₂O), of purity greater than 99.5% by mass, for example 2
Lithium chloride LiCl, of purity greater than 99.5% by mass, for the examples 1 to 2,
Hydrochloric acid HCl, of purity greater than 99% by mass, in 16M aqueous solution, for example 2,
An ammonium alginate of purity greater than 99% by mass, for example 2.

The product of example 1 (comparison) was obtained in the following manner:

A precipitation of boehmite is carried out as follows. 2500 g of aluminum trichloride hexahydrate (AlCl₃,6H₂O) are added to 3950 g of demineralized water, the solution being kept stirred in a 30 liter dual-jacketed stainless steel reactor. Then, still while being stirred, a solution of 1200 g of sodium hydroxide (NaOH) and 3 liters of demineralized water are added gradually, so as to adjust the pH. The pH reached at the end of synthesis is equal to 8. The temperature is maintained at 20° ° C. throughout the boehmite precipitation step. The precipitate of boehmite is then washed and filtered using a filter press. The water content of the boehmite precipitate at the end of this step is 85% by mass.

Next, 2500 g of said boehmite precipitate are then pulsed in 1600 g of demineralized water at room temperature, then a solution containing 170 g of LiCl and 16.7 liters of demineralized water is added (which corresponds to a Li/Al molar ratio equal to 0.39), the mixture being stirred and heated at 80° C. for 1 hour.

The mixture thus obtained is cooled to 60° C., then filtered in a filter press so as to obtain a paste. The paste thus obtained has the characteristics shown in Table 1 below.

TABLE 1

| | |
|---|---|
| Quantity of water, in percentage by mass | 85% |
| Crystallized phases demonstrated | Lithiated |
| | bayerite |

Chemical analysis by inductively coupled plasma spectrometry, after
drying in air at 200° C. for 16 hours, in percentage by weight

| | |
|---|---|
| Li content (%) | 2.11 |
| Cl content (%) | 10.78 |
| Al content (%) | 25.2 |
| Contents in elements other than Li, Al, Cl, O and H (%) | 2.3 |
| of which Na | 2.2 |
| O and H elements (%) | Supplement |
| | to 100 |

Said paste is then air-dried at 50° C. until its water content is equal to 50%. Next, 120 g of said dried paste, still at a temperature equal to 50° C., are introduced into a Z-arm mixer. Then 2.38 g of an oxalic acid solution at 10 g/L are added to said pulp with stirring. A homogeneous mixture is obtained, which is spread on a metal grid of thickness equal to 1 mm and perforated with circular holes of diameter equal to 1.5 mm, then scraped with a spatula on each side of the grid so that said mixture fills the holes of said grid. The grid is then called “charged”. Once the grid is charged, it is placed under a circulation of hot air at 60° C., which makes it possible to “discharge” said grid, the objects formed falling into a container placed under the grid. The objects obtained are in the form of cylinders of average length equal to 0.8 mm and of average diameter equal to 1.4 mm.

The product of example 2 (according to the invention) was obtained in the following manner:
500 g of aluminum hydroxide are added to 2,000 g of water, at a temperature equal to 25° C., in a LabStar mill marketed by NETZSCH and ground for 75 minutes. At the end of this step, the aluminum hydroxide suspended in water has a median size of 0.55 μm. 134.15 g of (LiOH, H₂O) is then added such that the molar ratio between the OH provided by (LiOH, H₂O) and the Al initially present in the mixture is equal to 0.5. The solution is mixed for a duration equal to 5 minutes, the temperature being maintained at 25° C. Then LiCl is added, in such a way that the molar ratio between the C1 supplied by LiCl and the Al initially present in the mixture is equal to 1, the solution is mixed for a duration equal to 5 minutes, the temperature being kept at 25° C. The Li/Al molar ratio is equal to 1.5.

The mixture is then heated using a heating plate, at a temperature equal to 60° C., the time during which said mixture is at a temperature greater than or equal to 50° C. being equal to 15 minutes. The mixture is then kept at a temperature equal to 60ºC for a duration equal to 45 minutes. Then, HCl is added in the mixture, so that the pH of the mixture is lowered to a value equal to 3, the value of the molar ratio Cl/Al in the mixture after addition of HCl being equal to 1.6, the mixing time being equal to 15 minutes, and the temperature being kept equal to 60° C. Finally, the mixture thus obtained is filtered on a Büchner funnel, at ambient temperature (below 50° C.), with filter papers with permeability equal to 2 μm so as to obtain a paste. During filtration, the time during which the mixture is at a temperature greater than or equal to 50° C. is equal to 5 minutes.

The paste thus obtained has the characteristics shown in Table 2 below.

TABLE 2

| | |
|---|---|
| Quantity of water, in percentage by mass | 65% |
| Crystallized phases demonstrated | Lithiated |
| | bayerite |

Chemical analysis by inductively coupled plasma spectrometry, after
drying in air at 200° C. for 16 hours, in percentage by weight

| | |
|---|---|
| Li content (%) | 4.21 |
| Cl content (%) | 21.51 |
| Al content (%) | 19.1 |
| Contents in elements other than Li, Al, Cl, O and H (%) | 0.1 |
| of which Na | 0.033 |
| O and H elements (%) | Supplement |
| | to 100 |

The obtained paste consists of more than 99% by mass of water, lithiated bayerite and LiCl.

Then, a feedstock conforming to the subject matter of the present invention was carried out, formed by a mixture of said paste obtained after filtration and of ammonium alginate, the content of said alginate being equal to 1% by mass relative to the mass of the feedstock, after drying at 200° C. for 16 hours.

Said paste containing lithiated bayerite and ammonium alginate were mixed in a planetary mixer under hot air created by a thermal stripper set to a temperature equal to 100° C., for 120 minutes so as to obtain a homogeneous feedstock and having a water content compatible with the shaping technique.

The starting load was then spread on a metal grid with a thickness of 1 mm and perforated with circular holes with a diameter of 1.5 mm, then scraped with a spatula on each side of the grid so that said starting charge fills the holes of said grid. The grid is then called “charged”. Once the grid is charged, it is placed under a circulation of hot air at 60° C., which makes it possible to “discharge” said grid, the objects formed falling into a container placed under the grid. The objects obtained are in the form of cylinders of average length equal to 0.8 mm and of average diameter equal to 1.4 mm.

The resistance to repetitive lithium adsorption-desorption cycles of the objects of examples 1 and 2 was then determined according to the following protocol.

For each example, 5 g of product are introduced into a beaker, then 20 mL of an aqueous lithium chloride solution with a concentration equal to 0.02 mol/L are poured into said beaker. The products of the example are left for 3 hours in contact with said aqueous lithium chloride solution. This contact corresponds to a step of lithium desorption. The products are then separated from said aqueous solution of lithium chloride, after having been briefly stirred, which makes it possible to observe the possible presence of a whitish veil. After separation, said products are then brought into contact for 3 hours with 20 ml of a brine having a lithium concentration equal to 0.06 mol/L. This contact corresponds to a step of lithium adsorption. The products are then separated from said brine, after having been briefly stirred, which makes it possible to observe the possible presence of a whitish veil. The desorption step followed by the adsorption step corresponds to a simulation of a lithium adsorption-desorption cycle.

The product undergoes 10 lithium adsorption-desorption cycles in all.

It is verified during the first cycle that the products of example 1 and example 2 release lithium during the desorption step and adsorb lithium during the adsorption step.

For the comparison product of example 1, the appearance of a whitish veil that cloud the aqueous lithium chloride solution and brine at the end of the desorption step and at the end of the adsorption step is observed during each cycle. This veil is the sign of the degradation of the product of example 1 during each lithium adsorption-desorption cycle.

Unlike the product of example 1, the product of example 2, according to the invention, does not generate this phenomenon, even after 10 lithium adsorption-desorption cycles: the aqueous solution of lithium chloride and brine remain perfectly clear at the end of the desorption step and at the end of the adsorption step, respectively. The product of example 2 according to the invention therefore has better resistance to repeated lithium adsorption-desorption cycles than the comparison product of example 1.

Of course, the invention is not limited to the embodiments described, which are provided merely for illustrative purposes.

1. A product for the extraction of lithium from a brine, said product comprising particles bound by a binder, said binder comprising a gelled polysaccharide comprising a group establishing an ionic bond with a divalent cation, a trivalent cation and mixtures thereof, said particles being particles of a lithium adsorbent.

2. The product according to claim 1, wherein the gelled polysaccharide comprises a group establishing an ionic bond with an alkaline earth cation.

3. The product according to claim 2, wherein the gelled polysaccharide comprises a group establishing an ionic bond with Ca, Sr, Ba cations and mixtures thereof.

4. The product according to claim 2, wherein said group is chosen from carboxylate groups or sulfonate groups.

5. The product according to claim 1, wherein the gelled polysaccharide is a gelled alginate under the action of a divalent cation, a trivalent cation and mixtures thereof.

6. The product according to claim 1, wherein the gelled polysaccharide is a gelled alginate under the action of a divalent cation, a trivalent cation and mixtures thereof.

7. The product according to claim 1, wherein the lithium adsorbent is selected from:
a lithiated bayerite;
a lithium aluminate, optionally hydrated and/or doped;
an optionally doped manganese spinel;
a lithiated iron oxide, optionally hydrated and/or doped;
a lithiated magnesium oxide, optionally hydrated and/or doped;
a cobalt and lithium spinel, optionally hydrated and/or doped;
a lithium titanate, optionally hydrated and/or doped;
H₂TiO₃ optionally hydrated and/or doped;
H₂Ti₃O₇ optionally hydrated and/or doped;
H₄T₁₅O₁₂, optionally hydrated and/or doped;
and mixtures thereof.

8. The product according to claim 7, wherein the lithium adsorbent is selected from:
a lithiated bayerite;
an optionally doped lithium and manganese spinel;
a lithium titanate, optionally hydrated and/or doped;
H₂TiO₃ optionally hydrated and/or doped;
and mixtures thereof.

9. The product according to claim 8, wherein the lithium adsorbent is lithiated bayerite.

10. The product according to claim 1, wherein a mass proportion of particles of the lithium adsorbent, after drying at 100° C. for 12 hours, is greater than or equal to 95% and less than 99.9% of a total mass of said product.

11. The product according to claim 1, wherein the product is in the form of cylinders, polylobes, rings, or spheres, a greatest dimension of which is less than 100 mm, and a smallest dimension of which, in a plane perpendicular to a direction of the largest dimension, is greater than 1 μm.

12. A method for manufacturing a product comprising a lithium adsorbent, the method comprising:
a) mixing raw materials to form a feedstock, said feedstock comprising a powder of a lithium adsorbent, and a polysaccharide that gels under the action of a gelling agent,
b) shaping said feedstock, so as to obtain a preform,
c) contacting said preform with said gelling agent in order to gel said polysaccharide so as to obtain said product comprising a lithium adsorbent, and
d) optionally drying said product comprising a lithium adsorbent.

13. The manufacturing method according to claim 12, wherein the lithium adsorbent is lithiated bayerite.

14. The manufacturing method according to claim 12, wherein the polysaccharide is an alginate or a pectin.

15. The manufacturing method according to claim 12, wherein the gelling agent is chosen from Ca, Sr, Ba and mixtures thereof.

16. A device for collecting lithium, comprising a product according to claim 1.

17. The product according to claim 1, wherein the binder consists of said gelled polysaccharide.

18. The product according to claim 3, wherein the group establishes an ionic bond with Ca cation.

19. The product according to claim 7, wherein
the lithiated bayerite is a material of formula (LiCl)ₓ·2Al(OH)₃, nH₂O, where x is between 0.4 and 1 and n is between 0.01 and 10;
said lithium aluminate corresponds to the formula LiAlO₂ optionally hydrated and/or doped;
the optionally doped manganese spinel is chosen from a manganese spinel of formula Li₍₁₊ₓ₎Mn_{(2-y)}M′_{y}O₄ where −0.20≤x≤0.4 and 0≤y≤1, the element M′ being selected from the group consisting of aluminum, cobalt, nickel, chromium, iron, magnesium, titanium, vanadium, copper, zinc, gallium, calcium, niobium, yttrium, barium, silicon, boron, zirconium, lithium and mixtures thereof, the electroneutrality of said lithium manganate being ensured by the oxygen content;
said lithiated iron oxide corresponds to the formula LiFeO₂ optionally hydrated and/or doped;
said lithiated magnesium oxide corresponds to the formula LiMgO₂ optionally hydrated and/or doped;
said cobalt and lithium spinel corresponds to the formula LiCo₂O₄ optionally hydrated and/or doped, and
said lithium titanate being chosen from a lithium titanate corresponding to the formula LiTiO₂, Liz TiO₃, Liz Ti₃O₇, Li₄T₁₅O₁₂, and mixtures thereof, optionally hydrated and/or doped.

20. The product according to claim 8, wherein
the lithiated bayerite is a material of formula (LiCl)ₓ·2Al(OH)₃, nH₂O, where x is between 0.4 and 1 and n is between 0.01 and 10, and
said lithium titanate is chosen from a lithium titanate corresponding to the formula LiTiO₂, Liz TiO₃, Liz Ti₃O₇, Li+T₁₅O₁₂, and mixtures thereof, optionally hydrated and/or doped.
